(19) United States
(12) Patent Application Publication
(10) Pub. No.: US 2026/0267474 A1
(43) Pub. Date: Sep. 10, 2026

(54) DISPLAY DEVICE AND NON-TRANSITORY COMPUTER-READABLE STORAGE MEDIUM STORING PROGRAM

(71) Applicant: SEIKO EPSON CORPORATION, Tokyo (JP)

(72) Inventors: Shin KONDO, Matsumoto (JP); Atsushi SUZUKI, Matsumoto (JP)

(21) Appl. No.: 19/560,453

(22) Filed: Mar. 9, 2026

(30) Foreign Application Priority Data
Mar. 10, 2025 (JP) 2025-037132

(51) Int. Cl. G06F 3/0482; H04N 1/00

(52) U.S. Cl. CPC G06F 3/0482; H04N 1/00437; H04N 1/00482; H04N 1/00514; H04N 2201/0094

(57) ABSTRACT

A terminal device includes a terminal display section, a determination processing section, and a display processing section. The determination processing section, in a state in which the terminal display section displays a setting screen of a printing apparatus, determines whether a user is confused about an operation of the setting screen. Furthermore, when the determination processing section determines that the user is confused about the operation, the display processing section causes the terminal display section to display a proposal for operating the setting screen.

The present application is based on, and claims priority from JP Application Serial Number 2025-037132, filed Mar. 10, 2025, the disclosure of which is hereby incorporated by reference herein in its entirety.

### BACKGROUND

### 1 Technical Field

The present disclosure relates to a display device and a non-transitory computer-readable storage medium storing a program.

### 2 Related Art

In the related art, a technique for displaying settings for a printing apparatus is known. For example, JP-A-2004-276454 discloses a printer that displays a procedure of a setup process.

In recent years, it has been proposed to perform settings for a printing apparatus on the printing apparatus itself or on an apparatus other than the printing apparatus. However, printing apparatuses such as the printer described in JP-A-2004-276454 have an increasing number of functions, and when setting up the printing apparatus, a user may become confused about the setting operations and may not be able to easily perform the desired settings.

### SUMMARY

According to an aspect of the present disclosure, there is provided a display device including: a display section; a determination processing section that, in a state in which the display section displays a setting screen of a printing apparatus, determines whether a user of the printing apparatus is confused about an operation of the setting screen; and a display processing section that, when the determination processing section determines that the user is confused about the operation of the setting screen, causes the display section to display a proposal for operating the setting screen.

According to another aspect of the present disclosure, there is provided a non-transitory computer-readable storage medium storing a program for causing a processor of a display device including a display section to function as: a determination processing section that, in a state in which the display section displays a setting screen of a printing apparatus, determines whether a user of the printing apparatus is confused about an operation of the setting screen; and a display processing section that, when the determination processing section determines that the user is confused about the operation of the setting screen, causes the display section to display a proposal for operating the setting screen.

### BRIEF DESCRIPTION OF THE DRAWINGS

FIG. 1 is a diagram showing a configuration of a printing system.

FIG. 2 is a diagram showing a configuration of a terminal device.

FIG. 3 is a diagram showing an example of a screen displayed on a terminal display section.

FIG. 4A is a diagram showing an example of a screen displayed on the terminal display section.

FIG. 4B is a diagram showing an example of a screen displayed on the terminal display section.

FIG. 5 is a diagram showing an example of a screen displayed on the terminal display section.

FIG. 6 is a diagram showing a configuration of a server.

FIG. 7 is a diagram for describing processing of a server learning section.

FIG. 8 is a diagram showing an operation of a printing system.

FIG. 9A is a diagram showing an example of a screen displayed on the terminal display section.

FIG. 9B is a diagram showing an example of a screen displayed on the terminal display section.

FIG. 9C is a diagram showing an example of a screen displayed on the terminal display section.

FIG. 10A is a diagram showing an example of a screen displayed on the terminal display section.

FIG. 10B is a diagram showing an example of a screen displayed on the terminal display section.

FIG. 10C is a diagram showing an example of a screen displayed on the terminal display section.

FIG. 10D is a diagram showing an example of a screen displayed on the terminal display section.

### DESCRIPTION OF EMBODIMENTS

### 1 First Embodiment

### 1-1 Configuration of Printing System

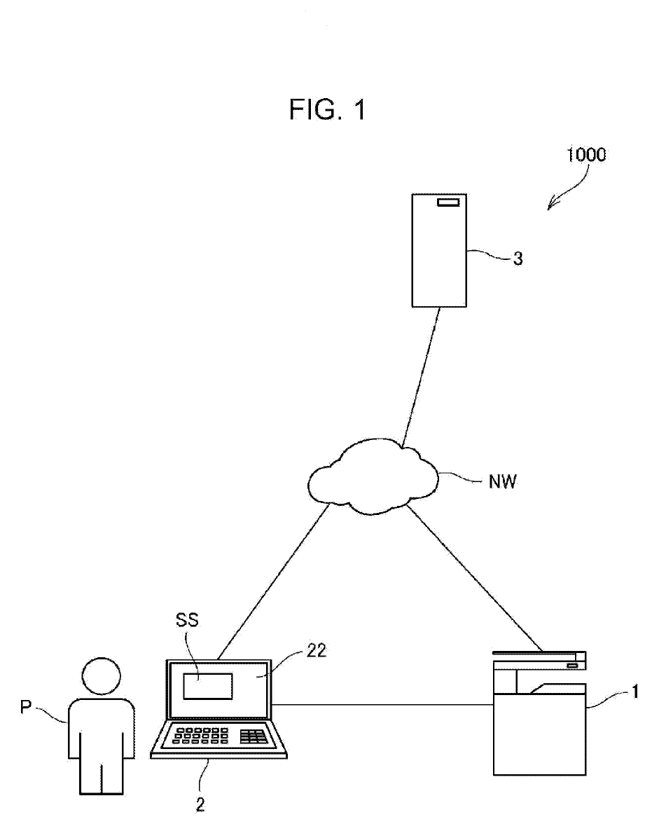

FIG. 1 is a diagram showing a configuration of a printing system 1000.

The printing system 1000 includes a printing apparatus 1, a terminal device 2, and a server 3.

The printing apparatus 1 is an apparatus that performs printing using a print head to generate printed matter. The printing apparatus 1 also has a scanning function and a copying function, and is an apparatus that generates printed matter, scans printed matter, and copies them. The printing apparatus 1 is connected to a terminal device 2 used by a user P of the printing apparatus 1 via a local area network (LAN), and communicates with the terminal device 2 via wired or wireless communication.

The printing apparatus 1 may also be connected to a network NW, which is a wide area network (WAN), and communicate with a server 3 connected to the network NW.

The terminal device 2 is a personal computer (PC) used by the user P. The user P can operate the terminal device 2 to cause the printing apparatus 1 to execute printing and to configure settings of the printing apparatus 1.

The terminal device 2 is an example of a “display device”.

Note that although FIG. 1 illustrates a case where the terminal device 2 is a laptop PC, the terminal device 2 may be a desktop PC, a tablet PC, or a smartphone.

The server 3 is connected to a network NW and communicates with the terminal device 2. The server 3 also stores programs related to the settings of the printing apparatus 1 and information related to the printing apparatus 1.

### 1-2 Configuration of Terminal Device

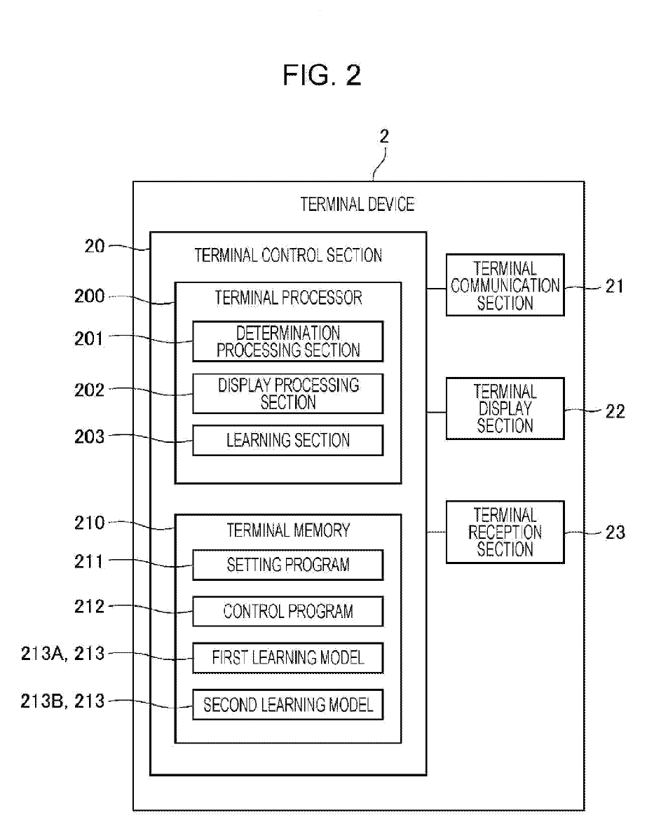

FIG. 2 is a diagram showing the configuration of the terminal device 2 according to a first embodiment.

The terminal device 2 includes a terminal control section 20, a terminal communication section 21, a terminal display section 22, and a terminal reception section 23.

The terminal display section 22 is an example of a “display section”. The terminal reception section 23 is an example of a “reception section”.

The terminal communication section 21 includes communication hardware such as a communication circuit, and communicates with the printing apparatus 1 under the control of the terminal control section 20.

The terminal display section 22 has a display and displays various types of information on the display under the control of the terminal control section 20.

The terminal reception section 23 is an interface that couples reception means such as an operation switch provided on the terminal device 2, a panel with a touch input function, a mouse, a keyboard, and the like, detects operations on the reception means, and outputs the detection results to the terminal control section 20. The terminal control section 20 executes processing corresponding to the operation on the reception means based on the input from the terminal reception section 23.

The terminal control section 20 includes a terminal processor 200 such as a central processing unit (CPU) or a Micro-processing unit (MPU), a terminal memory 210, and an interface circuit for coupling other devices and sensors. The terminal control section 20 controls each section of the terminal device 2. The terminal control section 20 is coupled to the terminal communication section 21, the terminal display section 22, and the terminal reception section 23.

The terminal memory 210 is a device that stores programs and data. The terminal memory 210 stores a setting program 211, a control program 212, a first learning model 213A, a second learning model 213B, data to be processed by the terminal processor 200, and the like. The terminal memory 210 has a non-volatile storage area. Also, the terminal memory 210 has a volatile storage area and constitutes a work area for the terminal processor 200. The terminal memory 210 is configured by, for example, a read only memory (ROM) or a random access memory (RAM).

The setting program 211 and the control program 212 are programs executed by the terminal processor 200.

The setting program 211 is a program for setting up the printing apparatus 1.

The control program 212 is a program for causing the terminal processor 200 to function as a determination processing section 201 and a display processing section 202, which will be described later.

The first learning model 213A and the second learning model 213B are models that are updated by a learning section 203, which will be described later. Differences between the first learning model 213A and the second learning model 213B will be described later. When the first learning model 213A and the second learning model 213B are not distinguished from each other, they are referred to as “learning models 213”.

The terminal processor 200 reads and executes the setting program 211 stored in the terminal memory 210 to cause the terminal display section 22 to display a setting screen SS. The setting screen SS is a setting screen for the printing apparatus 1, and in the present embodiment, an initial setting screen for the printing apparatus 1 is exemplified.

Furthermore, the terminal processor 200 functions as the determination processing section 201, the display processing section 202, and the learning section 203 by reading and executing the control program 212 stored in the terminal memory 210.

The determination processing section 201 determines whether the user P is confused about the operation of the setting screen SS. In the present embodiment, the determination processing section 201 uses the first learning model 213A to determine whether the user P is confused about the operation of the setting screen SS.

Here, the first learning model 213A will be described.

The first learning model 213A is a model that, when the display mode of the terminal display section 22 in a state in which the setting screen SS is displayed is input, outputs a determination result as to whether the user P is confused about the operation of the setting screen SS.

In the present embodiment, the input to the first learning model 213A is at least one of the following four.

The first input is a time during which the same screen is continuously displayed after a screen transition occurs on the setting screen SS. When the same screen continues to be displayed after a screen transition has occurred, the user P may be confused about the operation of the setting screen SS. Accordingly, there is a correlation between the first input and the output of the first learning model 213A.

The second input is a behavior of the cursor displayed on the terminal display section 22. In a state in which the setting screen SS is displayed, when the cursor remains within a predetermined range for a predetermined time or longer, or when the cursor wanders around the screen, the user P may be confused about the operation of the setting screen SS. Accordingly, there is a correlation between the second input and the output of the first learning model 213A.

The third input is a time during which the setting screen SS is in an inactive state.

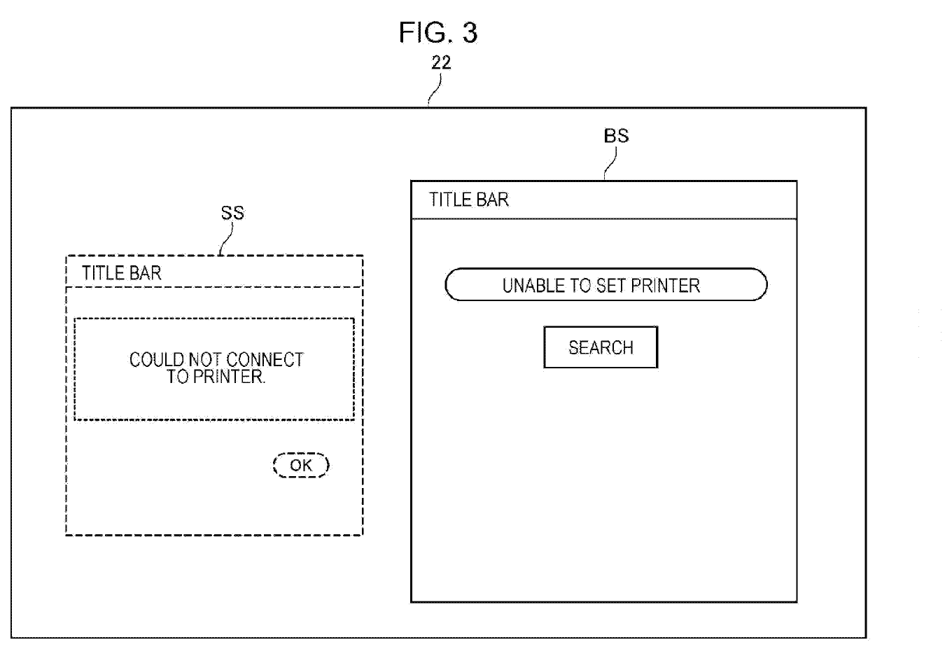

FIG. 3 is a diagram showing an example of the setting screen SS and a browser screen BS displayed on the terminal display section 22. For example, when the setting screen SS is in an inactive state, it is considered that the user P activates the browser screen BS and searches for operations on the setting screen SS. Accordingly, there is a correlation between the third input and the output of the first learning model 213A.

The fourth input is the number of screen transitions that have occurred on the setting screen SS.

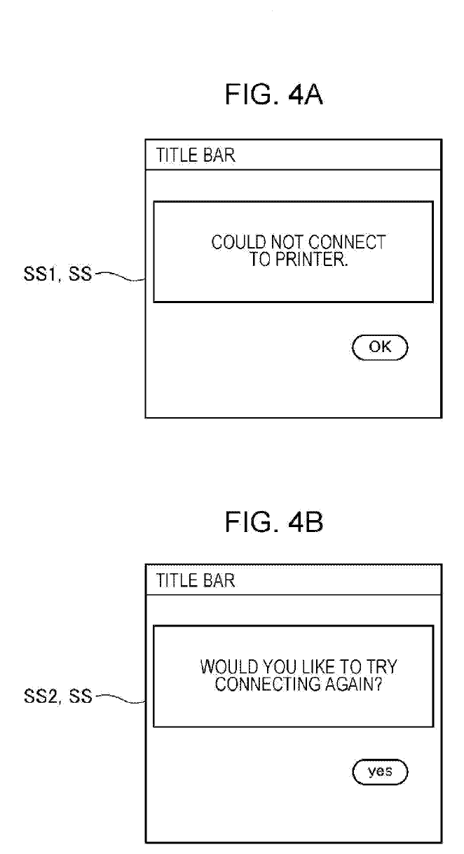

FIGS. 4A and 4B are diagrams showing examples of the setting screen SS displayed on the terminal display section 22. For example, when there are many screen transitions, such as when a setting screen SS1 of FIG. 4A and a setting screen SS2 of FIG. 4B are displayed alternately, it is possible that the user P is operating the setting screen SS but is unable to make the desired settings. Accordingly, there is a correlation between the fourth input and the output of the first learning model 213A.

The description of the first learning model 213A continues.

The first learning model 213A is a model that is machine-learned to determine whether the user P is confused about the operation of the setting screen SS. Machine learning is performed based on the display mode of the terminal display section 22 when the user P of the printing apparatus 1 is confused about the operation of the setting screen SS, and the display mode of the terminal display section 22 when the user P of the printing apparatus 1 is not confused about the operation of the setting screen SS. More specifically, the first learning model 213A is a model that has machine-learned a discriminative threshold value for determining whether the user P is confused about the operation of the setting screen SS based on the display mode of the terminal display section 22. In this manner, four types of display modes are input into the first learning model 213A. Therefore, the first learning model 213A is a model that has machine-learned a discriminative threshold value for determining whether the user P is confused about the operation of the setting screen SS for each of the four types of display modes.

When the determination processing section 201 determines that the user P is confused about the setting operation, the display processing section 202 causes the terminal display section 22 to display a proposal for operating the setting screen SS. Hereinafter, a proposal for operating the setting screen SS will be referred to as a “proposal” as appropriate.

Here, an example of a proposal of the display processing section 202 will be shown.

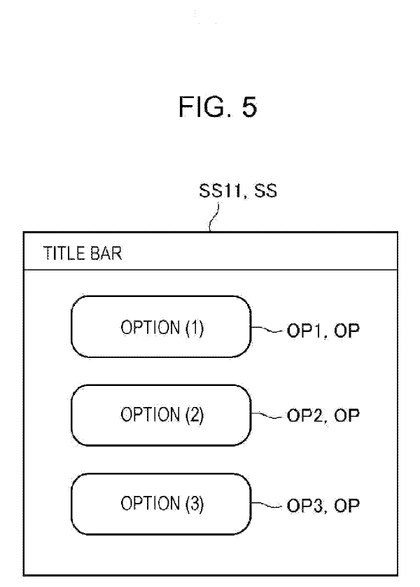

FIG. 5 is a diagram showing an example of the setting screen SS displayed on the terminal display section 22.

The display processing section 202 displays the proposal on the setting screen SS11. In FIG. 5, three options OP are displayed as proposals: a first option OP1, a second option OP2, and a third option OP3. Each of the first option OP1 to the third option OP3 is an operation option on the setting screen, and the user P can select the option.

The display processing section 202 causes the second learning model 213B to output a proposal and causes the terminal display section 22 to display the proposal obtained from the second learning model 213B.

Here, the second learning model 213B will be described.

The second learning model 213B is a model that is machine-learned from the setting screen SS when the user P is not confused about the operation of the setting screen SS. The second learning model 213B is a model that outputs proposals when the setting screen SS is input. In addition, the proposals output by the second learning model 213B include the type of option OP, the priority of proposing the option OP to the user P, and the like.

Further, the second learning model 213B is a model that outputs a solution when a question about the operation of the setting screen SS is input. For example, when the user P inputs a question regarding the operation of the setting screen SS using an interactive screen CS to be described below, the display processing section 202 inputs the content of the question into the second learning model 213B, and the second learning model 213B outputs the solution to the display processing section 202.

The learning section 203 is Artificial Intelligence (AI) and is configured from software or hardware that configures a neural network. The learning section 203 performs machine learning using the display mode of the terminal display section 22 in a state in which the setting screen SS is displayed, and updates the first learning model 213A stored in the terminal memory 210. That is, the learning section 203 updates the first learning model 213A such that the learning results are reflected.

In addition, the learning section 203 performs machine learning of a threshold value that the first learning model 213A applies to the display mode of the terminal display section 22 input to the first learning model 213A. The machine learning is performed based on at least one of the content of the operation of the user P on the terminal reception section 23 and the content of the interaction between the display device 1 and the user P. Then, the first learning model 213A applies the threshold value learned by the learning section 203 to the above input and outputs a determination result as to whether the user P is confused.

In addition, the learning section 203 performs machine learning using the content of the operation of the user P on the terminal reception section 23 and the content of the interaction between the display device 1 and the user P, and updates the second learning model 213B stored in the terminal memory 210.

### 1-3 Configuration of Server

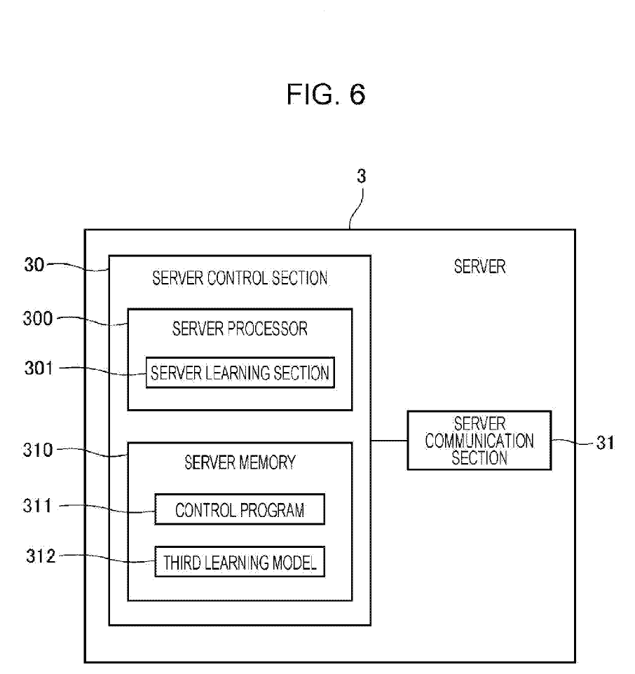

FIG. 6 is a diagram showing the configuration of the server 3.

The server 3 includes a server control section 30 and a server communication section 31.

The server communication section 31 includes communication hardware such as a communication circuit, and communicates with the terminal device 2 and the like under the control of the server control section 30.

The server control section 30 includes a server processor 300 such as a CPU or MPU, a server memory 310, and an interface circuit for coupling other devices and sensors, and controls each section of the server 3. The server communication section 31 is coupled to the server control section 30.

The server memory 310 is a device that stores programs and data. The server memory 310 stores a control program 311, a third learning model 312, data to be processed by the server processor 300, or the like. The server memory 310 has a non-volatile storage area. Also, the server memory 310 has a volatile storage area and constitutes a work area for the server processor 300. The server memory 310 is configured by, for example, a ROM or a RAM.

The control program 311 is a program for causing the server processor 300 to function as a server learning section 301, which will be described later.

The third learning model 312 is a learning model generated and updated by the server learning section 301.

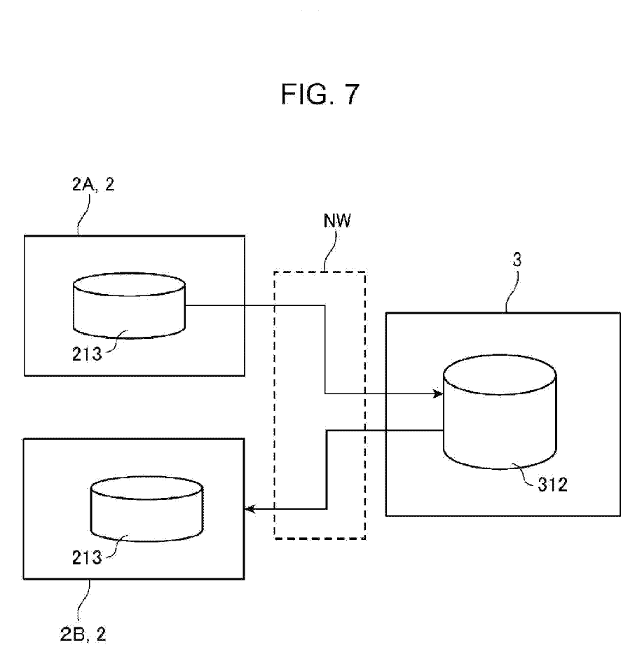

Here, the processing of the server learning section 301 will be described with reference to FIG. 7.

FIG. 7 is a diagram for describing the processing of the server learning section 301.

FIG. 7 illustrates a case where two terminal devices 2 are connected to the server 3 via the network NW. That is, FIG. 7 illustrates a case where a first terminal device 2A and a second terminal device 2B are connected to the server 3.

The server learning section 301 generates or updates the third learning model 312 using a learning model 213 of the first terminal device 2A. In addition, the server learning section 301 applies information of the learning model 213 of the first terminal device 2A to the learning model 213 of the second terminal device 2B.

Further, the information of the third learning model 312 can also be applied to learning models of other applications.

### 1-4 Operation of Each Section of Printing System

Next, the operation of each section of the printing system 1000 will be described.

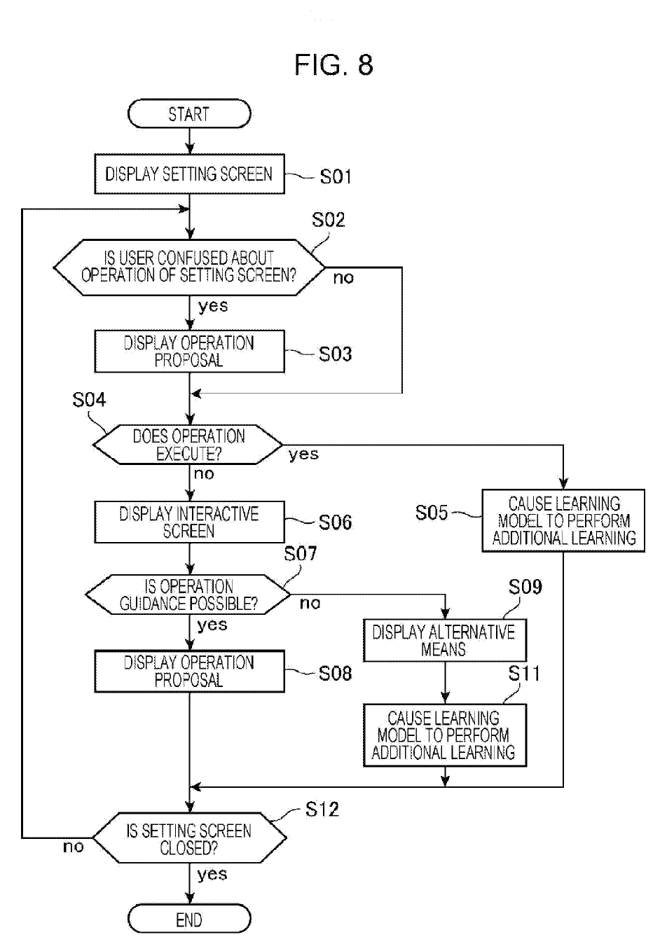

FIG. 8 is a flowchart showing the operation of the printing system 1000. Here, it is assumed that the learning model 213 has already been generated in the terminal device 2.

When the user P activates the setting program 211 by the operation input from the terminal reception section 23 of the terminal device 2, the display processing section 202 of the terminal processor 200 displays the setting screen SS on the terminal display section 22 (step S01).

Next, the determination processing section 201 determines whether the user P is confused about the operation of the setting screen SS (step S02).

In step S02, the determination processing section 201 inputs the display mode of the terminal display section 22 into the first learning model 213A and causes the first learning model 213A to output a determination result as to whether the user P is confused. Then, the determination processing section 201 makes a determination in step S02 based on the output from the learning model 213A.

When the determination processing section 201 determines that the user is not confused about the operation of the setting screen SS (step S02: NO), the terminal processor 200 proceeds to step S04.

When the determination processing section 201 determines that the user is confused about the operation of the setting screen SS (step S02: YES), the process proceeds to step S03.

In step S03, the display processing section 202 first inputs the setting screen SS displayed when the determination processing section 201 determines that the user P is confused into the second learning model 213B, and causes the second learning model 213B to output a proposal. Then, the display processing section 202 displays the proposal output by the second learning model 213B on the terminal display section 22. For example, as described above with reference to FIG. 5, the terminal display section 22 displays, as proposals, a plurality of operation options OP on a setting screen SS21.

Here, other display examples of proposals will be described.

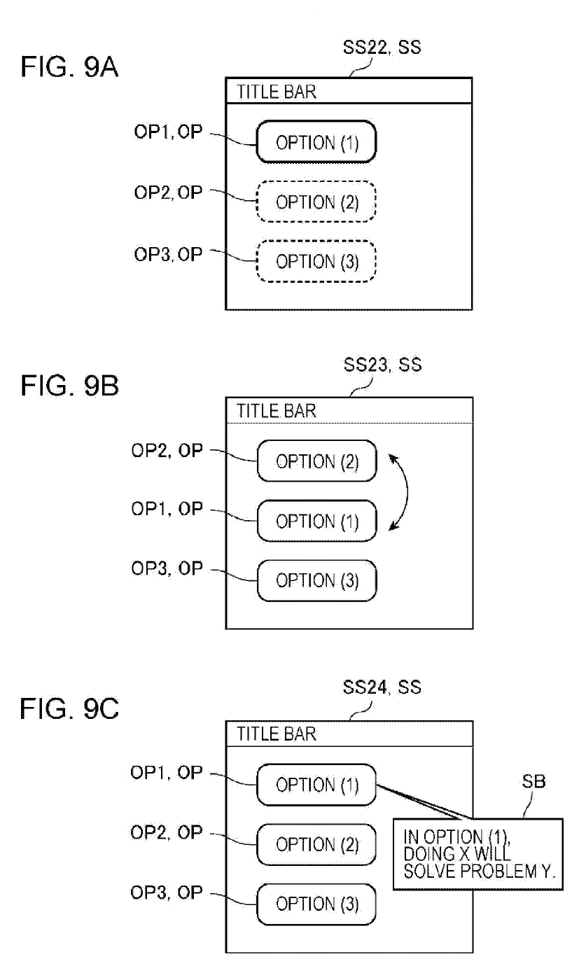

FIGS. 9A, 9B, and 9C are diagrams showing examples of the setting screen SS displayed on the terminal display section 22.

FIG. 9A shows an example in which the display mode of the first option OP1 having the highest priority to be proposed to the user P is displayed differently from the display modes of the other options on a setting screen SS22. Since options that are displayed in a conspicuous manner are more likely to be selected, the first option OP1 is displayed in bold and large characters, and the second option OP2 and the third option OP3 are displayed in small characters.

FIG. 9B shows an example in which options OP are rearranged according to the priority to be proposed to the user P on a setting screen SS23. Since the option displayed at the top is more likely to be selected, this is an example in which the options are rearranged such that the second option OP2, which has the highest priority, is displayed at the top.

FIG. 9C shows an example in which, when the first option OP1 is selected from the displayed options OP on a setting screen SS24, an explanation of the first option OP1 is displayed. The printing apparatus 1 often uses technical terms, and since there may be cases where the user P cannot understand the content, an explanation of the options is displayed.

Next, the display processing section 202 displays a proposal regarding the setting operation of the printing apparatus 1 on the terminal display section 22, and then determines whether the user P has performed an operation in accordance with the proposal (step S04).

The operation in accordance with the proposal is performed when the user P performs a setting operation of the printing apparatus 1 according to the content of the options displayed on the terminal display section 22. Also, when the setting of the printing apparatus 1 is successful, it is determined that the operation has been performed in accordance with the proposal.

When the display processing section 202 determines that the user P has performed an operation in accordance with the proposal (step S04: YES), the process proceeds to step S05.

In step S05, the learning section 203 determines that the proposal displayed on the terminal display section 22 is a successful case and causes the second learning model 213B to perform additional learning. For example, when the setting of the printing apparatus 1 is successful by performing operations in accordance with an option OP selected by the user P from among the operation options OP on the setting screen SS21, the second learning model 213B is updated such that the option OP selected by the user P has a higher priority.

In step S12, the terminal processor 200 determines whether the setting screen SS is closed. The setting screen SS is closed when, for example, the setting of the printing apparatus 1 has been successfully completed. On the other hand, when the setting screen SS is not closed, it means, for example, that the setting of the printing apparatus 1 is not ended.

When the terminal processor 200 determines that the setting screen SS is closed (step S12: YES), the flow ends. When the terminal processor 200 determines that the setting screen SS is not closed (step S12: NO), the process returns to step S02.

On the other hand, when the display processing section 202 determines that the user P has not performed the operation in accordance with the proposal (step S04: NO), the process proceeds to step S06.

Examples of cases where the user P does not perform an operation in accordance with the proposal include when the user P performs an operation different from the proposal displayed in step S03, or when the user P does not make any input from the terminal reception section 23 for a predetermined time after the proposal is displayed in step S03.

In step S06, the display processing section 202 causes the terminal display section 22 to display the interactive screen CS.

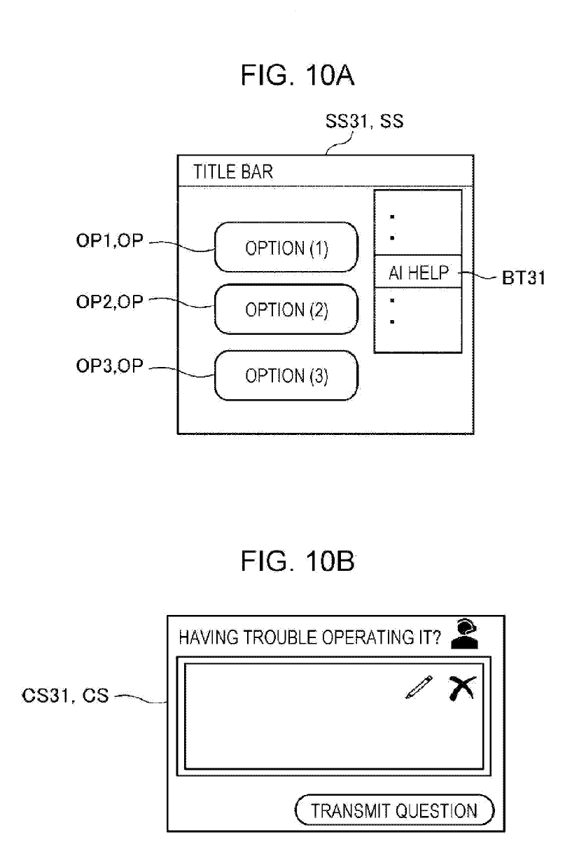

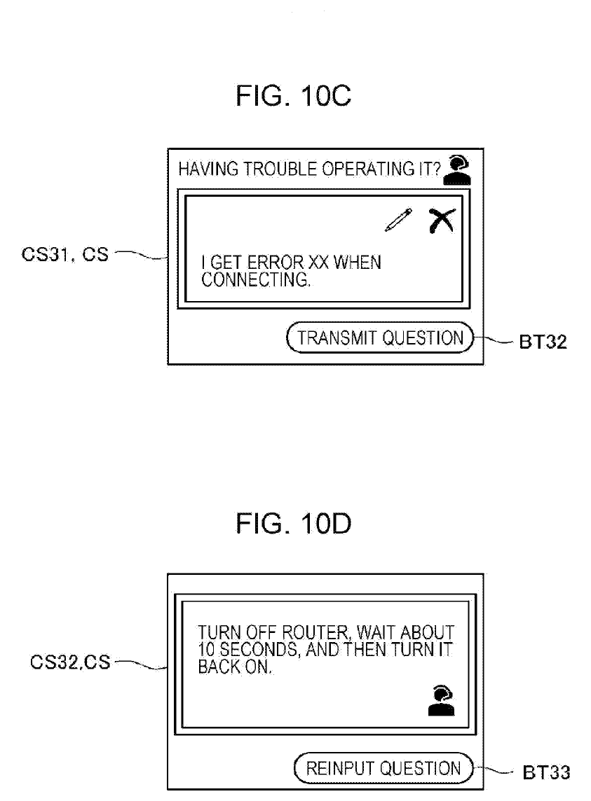

FIG. 10A is a diagram showing an example of the setting screen SS displayed on the terminal display section 22. FIGS. 10B, 10C, and 10D are diagrams showing examples of the interactive screen CS displayed on the terminal display section 22.

For example, on a setting screen SS31 shown in FIG. 10A, when the user P does not select any of the first option OP1 to the third option OP3, a button BT31 is displayed to prompt an interaction with an AI assistant.

When the user P clicks the button BT31, an interactive screen CS31 for interacting with the AI assistant is displayed, as shown in FIG. 10B.

On the interactive screen CS31, as shown in FIG. 10C, the user P can ask a question to the AI assistant by inputting the question and then clicking a transmission button BT32.

Next, the display processing section 202 determines whether operation guidance is possible (step S07).

The operation guidance being possible means being able to propose a solution to a question input on the interactive screen CS based on the learning content of the second learning model 213B. For example, when the display processing section 202 inputs the content of the question of the user P into the second learning model 213B, and the second learning model 213B can output a solution to the question to the display processing section 202, operation guidance is possible.

When operation guidance is possible (step S07: YES), the display processing section 202 causes the terminal display section 22 to display an interactive screen CS33 as shown in FIG. 10D, which indicates the operation content that the user P should perform next.

When operation guidance is not possible (step S07: NO), the display processing section 202 displays alternative means (step S09).

A case where operation guidance is not possible is when the content of the question of the user P is about a function that cannot be realized by the printing apparatus 1 or the terminal device 2, and the learning model 213B cannot output a solution.

For example, it is assumed that the user P inputs a question on an interactive screen CS32 asking when he or she would like to connect to the printing apparatus 1 using a wired LAN. However, when the terminal device 2 does not have a terminal for connecting to a wired LAN, it is not possible to provide operation guidance corresponding to the question of the user P.

In this case, the learning section 203 causes the second learning model 213B to output a solution for a case similar to the content of the question of the user P. When the second learning model 213B outputs a wireless LAN connection as a solution, the display processing section 202 displays, on the terminal display section 22, a proposal recommending a wireless LAN connection as alternative means.

In step S11, the learning section 203 causes the second learning model 213B to additionally learn the above alternative means.

### 1-5 Configuration and Effects

As described above, the terminal device 2 includes the terminal display section 22, the determination processing section 201, and the display processing section 202. The determination processing section 201 determines whether the user P is confused about the operation of the setting screen SS in a state in which the terminal display section 22 displays the setting screen SS of the printing apparatus 1. Furthermore, when the determination processing section 201 determines that the user P is confused about the operation, the display processing section 202 displays a proposal for operating the setting screen SS on the terminal display section 22. This allows the user P to easily perform the desired settings even when the user P is confused about the operation of the setting screen SS.

The terminal device 2 includes the first learning model 213A that is machine-learned to learn the display mode of the terminal display section 22 in a state in which the terminal display section 22 displays the setting screen SS of the printing apparatus 1. The determination processing section 201 inputs the display mode of the terminal display section 22 in a state in which the setting screen SS is displayed on the terminal display section 22 to the first learning model 213A, and outputs a determination result from the first learning model 213A as to whether the user P is confused. When the determination result output by the first learning model 213A is a determination result that the user P is confused, the determination processing section 201 determines that the user P is confused.

According to this, the display mode of the terminal display section 22 in a state in which the setting screen SS is displayed on the terminal display section 22 is learned, and then it is determined whether the user P is confused about the operation of the setting screen SS. Therefore, it is possible to accurately determine whether the user P is confused about the operation of the setting screen SS.

The determination processing section 201 inputs the time during which the same screen is continuously displayed after a screen transition occurs on the setting screen SS into the first learning model 213A as the display mode of the terminal display section 22.

According to this, the time during which the same screen is continuously displayed after a screen transition occurs on the setting screen SS is learned, and then it is determined whether the user P is confused about the operation of the setting screen SS. Therefore, it is possible to more accurately determine whether the user P is confused about the operation of the setting screen SS.

The determination processing section 201 inputs the behavior of the cursor displayed by the terminal display section 22 into the first learning model 213A as the display mode of the terminal display section 22.

According to this, since the behavior of the cursor displayed by the terminal display section 22 is learned, and then it is determined whether the user P is confused about the operation of the setting screen SS, it is possible to accurately determine whether the user P is confused about the operation of the setting screen SS.

The determination processing section 201 inputs the time during which the setting screen SS is in an inactive state into the first learning model 213A as the display mode of the terminal display section 22.

According to this, since the time during which the setting screen SS is in an inactive state is learned, and then it is determined whether the user P is confused about the operation of the setting screen SS, it is possible to accurately determine whether the user P is confused about the operation of the setting screen SS.

The determination processing section 201 inputs the number of screen transitions that occurred on the setting screen SS into the first learning model 213A as the display mode of the terminal display section 22.

According to this, since the number of screen transitions that occurred on the setting screen SS is learned, and then it is determined whether the user P is confused about the operation of the setting screen SS, it is possible to accurately determine whether the user P is confused about the operation of the setting screen SS.

The terminal device 2 includes the terminal reception section 23 and the learning section 203. The terminal reception section 23 receives an operation of the user P. The learning section 203 learns the threshold value to be applied by the first learning model 213A to the input display mode of the terminal display section 22 based on at least one of the content of the operation of the user P on the terminal reception section 23 and the content of the interaction between the display device 1 and the user P. The first learning model 213A applies the threshold value learned by the learning section 203 to the input and outputs a determination result as to whether the user P is confused.

According to this, the learning section 203 learns the threshold value to be applied by the first learning model 213A based on at least one of the content of the operation of the user P on the terminal reception section 23 and the content of the interaction between the display device 1 and the user P. Therefore, it is possible to more accurately determine whether the user P is confused about the operation of the setting screen SS.

The display processing section 202 displays a plurality of operation options on the setting screen SS as proposals. The display processing section 202 causes the display mode of the option having the highest priority to be proposed to the user P out of the plurality of options to differ from the display modes of the options other than the options having the highest priority.

This allows the user P to easily ascertain the proposals for making the desired settings.

The display processing section 202 displays a plurality of options for operating the setting screen SS as proposals. The display processing section 202 rearranges the plurality of options according to the priority to be proposed to the user P.

This also allows the user P to easily ascertain the proposals for making the desired settings.

The display processing section 202 displays a plurality of options for operating the setting screen SS as proposals. When one of the displayed options is selected, the display processing section 202 causes the terminal display section 22 to display an explanation of the selected option.

This allows the user P to understand the content proposed by the display processing section 202, and thus allows the user P to easily ascertain the proposals for making the desired settings.

The terminal device 2 includes the second learning model 213B that learned the setting screen SS when the user P is not confused. The display processing section 202 inputs the setting screen SS displayed when the determination processing section 201 determines that the user P is confused into the second learning model 213B, and causes the second learning model 213B to output a proposal. The display processing section 202 displays the proposal output by the second learning model 213B.

According to this, when the user P is not confused, that is, when the printing apparatus 1 is considered to be set correctly, the setting screen SS is learned and proposals are output. Therefore, the accuracy of proposals for the user P to make the desired settings can be improved.

The terminal device 2 includes the terminal reception section 23 and the learning section 203. The terminal reception section 23 receives an operation of the user P. The learning section 203 learns proposals based on at least one of the content of the operation of the user P on the terminal reception section 23 and the content of the interaction between the display device 1 and the user P. The second learning model 213B outputs the proposals learned by the learning section 203. According to this, proposals are learned based on the content of the operation of the user P on the terminal reception section 23 or the content of the interaction between the display device 1 and the user P, and then the proposals are output. Therefore, the accuracy of proposals for the user P to make the desired settings can be improved.

The control program 212 causes the terminal processor 200 of the terminal device 2 including the terminal display section 22 to function as the determination processing section 201 and the display processing section 202.

The determination processing section 201 determines whether the user P, who is the user of the printing apparatus 1, is confused about the operation of the setting screen SS in a state in which the terminal display section 22 displays the setting screen SS of the printing apparatus 1. When the determination processing section 201 determines that the user P is confused about the operation of the setting screen SS, the display processing section 202 causes the terminal display section 22 to display a proposal for operating the setting screen SS.

According to this, the same effect as that of the terminal device 2 can be obtained.

### 2 Other embodiments

The above-described embodiment is the preferred embodiment of the present disclosure. However, various modifications can be made without being limited to the above-described embodiments within the spirit of the present disclosure.

In the above-described embodiment, the terminal device 2 is exemplified as a “display device”. In another embodiment, the “display device” may be other electronic devices equipped with a display section, such as a television device, a projector, or a printing apparatus such as a copying machine.

Furthermore, the functions of the terminal control section 20 and the server control section 30 may be realized by a plurality of processors or semiconductor chips.

In addition, in the above-described embodiment, the terminal device 2 is configured to include the learning section 203 and the learning model 213, but these may also be included in other devices such as the server 3. In the above-described embodiment, the terminal memory 210 is configured to include the setting program 211 and the control program 212. In another embodiment, the control program 212 may be incorporated into the setting program 211.

In addition, the learning section 203 may construct a second learning model 213B such that the display processing section 202 displays different proposals depending on whether the printing apparatus 1 that the user P is attempting to set up is a business model or a consumer model.

In addition, when the printing apparatus 1 that the user P is attempting to set up is a consumer model, the learning section 203 may cause the threshold value to be applied by the first learning model 213A to the input display mode of the terminal display section 22 to differ from that in the case of a business model.

In the above-described embodiment, examples of the display mode of options having a higher priority proposed to the user include enlarging the characters and making the character bold. Alternatively, the character of options having a higher priority may be displayed in a different color than the other options.

In the above-described embodiment, an example has been shown in which the determination processing section 201 determines whether the user P of the printing apparatus 1 is confused about the operation of the printing apparatus 1 based on the determination result output from the learning model 213A. In another embodiment, the determination processing section 201 itself may have a determination reference for the confusion, and the determination processing section 201 may make the above determination based on this determination reference.

In the above-described embodiment, an example has been shown in which the display processing section 202 displays a proposal for setting operations of the printing apparatus 1 based on the content output from the learning model 213B. In another embodiment, the display processing section 202 itself may include information regarding the proposal for setting operations of the printing apparatus 1.

In the above-described embodiment, the second learning model 213B that learned the setting screen SS when the user P is not confused is exemplified.

In another embodiment, the second learning model 213B may learn information about a PC environment of the terminal device 2, such as the memory usage status of the terminal device 2 when the user P is not confused, and whether software or applications are being used in an unrecommended environment. In addition, information about the network environment, such as the number of SSIDs acquired for the network to which the terminal device 2 is connected, the radio wave strength and link speed of the wireless network, the encryption status of the network, and the setting content of the IP address of the device, may be learned.

In another embodiment, the second learning model 213B may learn information held by a call center that handles user inquiries related to the printing apparatus 1. For example, the second learning model 213B may learn records of the content of the user’s problem, the solution procedures presented by the call center for the problem, and whether the problem was solved by presenting the solution procedures.

In another embodiment, the second learning model 213B may learn information regarding the minimum guidance to be presented to the user when the terminal device 2 is offline. For example, information such as recommending a network connection or recommending the USB connection to another device may be learned.

In another embodiment, the second learning model 213B may learn data collected by a tool that measures or analyzes access data of a website.

In the above-described embodiment, the first learning model 213A that is machine-learned to learn the display mode of the terminal display section 22 in a state in which the terminal display section 22 displays the setting screen SS of the printing apparatus 1 is exemplified.

In another embodiment, the first learning model 213A may be made to learn the time from when a subject views the setting screen SS to when the subject answers that he or she is confused.

In addition, as the behavior of the cursor displayed by the terminal display section 22, the time required until the character of the explanation of the setting screen SS is completely read may be learned by the first learning model 213A. The first learning model 213A may also be made to learn the time it takes to place the cursor over a button, read the character of the operation explanation, and then determine that the explanatory sentences alone are not enough to understand.

In the above-described embodiment, when the setting of the printing apparatus 1 is successful by performing operations in accordance with an option OP selected by the user P from among the operation options OP on the setting screen SS21, the second learning model 213B is updated such that the selected option OP has a higher priority.

In another embodiment, the second learning model 213B is updated such that the priority of the options OP not selected by the user P among the operation options OP on the setting screen SS21 is lowered. Furthermore, when the setting of the printing apparatus 1 is not successful even when the user P performs the operation in accordance with the option OP selected by the user P, the priority of the option OP selected by the user P may be lowered.

Furthermore, the configuration of each section of the terminal device 2 shown in FIG. 2 and the configuration of each section of the server 3 shown in FIG. 6 indicate functional configurations, and the specific implementation form is not particularly limited. That is, it is not always necessary to mount hardware that individually corresponds to each functional section, and a configuration may be employed in which one processor realizes a plurality of functions by executing a program. In addition, in the above embodiments, a part of the function realized by the software may be realized by the hardware, and a part of the function realized by the hardware may be realized by the software. In addition, the specific detailed configurations of other sections of the printing apparatus 1, the terminal device 2, and the server 3 can also be changed as desired without departing from the spirit of the present disclosure.

In addition, the processing units in the flowchart shown in FIG. 8 are divided according to the main processing content to make it easier to understand the processing of each section of the printing system 1000, and the present disclosure is not limited by the way in which the processing units are divided or their names. The processing content may be divided into many step units. Further, one step unit may be divided to include a large amount of processing. Furthermore, the order of the steps may be appropriately changed within a range that does not interfere with the spirit of the present disclosure.

What is claimed is:

1. A display device comprising:
a display section;
a determination processing section that, in a state in which the display section displays a setting screen of a printing apparatus, determines whether a user of the printing apparatus is confused about an operation of the setting screen; and
a display processing section that, when the determination processing section determines that the user is confused about the operation of the setting screen, causes the display section to display a proposal for operating the setting screen.

2. The display device according to claim 1, further comprising:
a first learning model that is machine-learned to learn a display mode of the display section in a state in which the display section displays the setting screen of the printing apparatus, wherein
the determination processing section
inputs the display mode of the display section in the state in which the display section displays the setting screen into the first learning model, and causes the first learning model to output a determination result as to whether the user is confused, and
determines that the user is confused when the determination result output by the first learning model is a determination result that the user is confused.

3. The display device according to claim 2, wherein
the determination processing section inputs a time during which the same screen is continuously displayed after a screen transition occurs on the setting screen into the first learning model as the display mode of the display section.

4. The display device according to claim 2, wherein
the determination processing section inputs a behavior of a cursor displayed by the display section into the first learning model as the display mode of the display section.

5. The display device according to claim 2, wherein
the determination processing section inputs a time during which the setting screen is in an inactive state into the first learning model as the display mode of the display section.

6. The display device according to claim 2, wherein
the determination processing section inputs the number of screen transitions that occurred on the setting screen into the first learning model as the display mode of the display section.

7. The display device according to claim 2, further comprising:
a reception section that receives a user operation; and
a learning section that learns a threshold value to be applied by the first learning model to the input display mode of the display section based on at least one of content of the user operation on the reception section and content of an interaction between the display device and the user, wherein
the first learning model applies the threshold value learned by the learning section to the input and outputs the determination result as to whether the user is confused.

8. The display device according to claim 1, wherein
the display processing section
displays, as the proposal, a plurality of options for an operation on the setting screen, and
causes a display mode of the option having a highest priority to be proposed to the user among the plurality of options to differ from a display mode of the option other than the option having the highest priority.

9. The display device according to claim 1, wherein
the display processing section displays, as the proposal, a plurality of options for an operation on the setting screen, and rearranges the plurality of options according to a priority to be proposed to the user.

10. The display device according to claim 1, wherein
the display processing section
displays, as the proposal, a plurality of options for an operation on the setting screen, and
when one of the displayed options is selected, causes the display section to display an explanation of the selected option.

11. The display device according to claim 1, further comprising:
a second learning model that learned the setting screen when the user is not confused, wherein
the display processing section
inputs the setting screen when the determination processing section determines that the user is confused into the second learning model, and causes the second learning model to output the proposal, and
displays the proposal output by the second learning model.

12. The display device according to claim 11, further comprising:
a reception section that receives a user operation; and
a learning section that learns the proposal based on at least one of content of the user operation on the reception section and content of an interaction between the display device and the user, wherein
the second learning model outputs the proposal learned by the learning section.

13. A non-transitory computer-readable storage medium storing a program for causing a processor of a display device including a display section to function as:
a determination processing section that, in a state in which the display section displays a setting screen of a printing apparatus, determines whether a user of the printing apparatus is confused about an operation of the setting screen; and
a display processing section that, when the determination processing section determines that the user is confused about the operation of the setting screen, causes the display section to display a proposal for operating the setting screen.
